(19) United States
(12) Patent Application Publication
(10) Pub. No.: US 2009/0089181 A1
(43) Pub. Date: Apr. 2, 2009

(54) Methods and systems for conducting transactions with wireless communications devices using a secure interactive service

(76) Inventor: John R. Mathis,, JR., LaCrosse, IN (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/285,310

(22) Filed: Oct. 1, 2008

Related U.S. Application Data
(60) Provisional application No. 60/960,482, filed on Oct. 1, 2007.

(51) Int. Cl. G06Q 30/00; G06F 15/16; H04W 4/12

(52) U.S. Cl. 705/26; 709/206; 455/466

(57) ABSTRACT

Methods and systems are provided for conducting a secure transaction with a wireless communications device. According to one implementation, a virtual call center receives an electronic message from the wireless communications device. The electronic message may include a key text phrase and be addressed to an automated service identifier. The virtual call center determines transaction information based on at least one of the key text phrase, the automated service identifier, or an identifier of the wireless communications device. The transaction information includes at least an identity of a merchant. The virtual call center then initiates or provides to the wireless communications device a secure interactive service to receive at least private information and receives at least the private information through the secure interactive service. Thereafter, the virtual call center can complete the secure transaction by providing at least the transaction information and the private information to the merchant.

### RELATED APPLICATION(S)

This application claims the benefit of priority of U.S. Provisional Patent Application No. 60/960,482, filed Oct. 1, 2007, entitled “Virtual Call Center Mobile,” the entire disclosure of which is expressly incorporated herein by reference.

### BACKGROUND

1. Technical Field

The present invention generally relates to wireless communications devices and technology for conducting secure transactions. More particularly, and without limitation, the invention relates to methods and systems for conducting transactions with wireless communications devices using a secure interactive service.

2. Background Information

The proliferation and advancements in wireless technology enable users to do more while using wireless communications devices. For example, cellular phones, personal digital assistants (PDAs), and other wireless communications devices enable users to perform a wide variety of operations, such as emailing, browsing the Internet, texting, chatting or instant messaging, blogging, calendaring, taking pictures and videos, recording audio, playing music, watching movies, etc.

The versatility of wireless communications devices has also opened the possibility for conducting transactions from any location and at any time. Certain transactions, however, such as transactions to purchase a good or service, are not widely accepted using conventional wireless technology due to various limitations. For example, certain information exchanged for a transaction may be considered private or confidential. Examples of private information for a transaction include name, address, and payment information (credit card number, bank wire instructions, etc.). Private information for a transaction should be transmitted securely, but conventional wireless technology (such as Short Message Service (SMS)) alone does not provide a secure method for communicating private information. Further, while encryption technologies (such as security-enabled WAP sites) are known, such technologies do not provide a simple and efficient process for enabling secure transactions with wireless communications devices.

In view of the foregoing, there is a need for improved methods and systems for conducting secure transactions using a wireless communications device. In addition, there is a need for methods and systems that facilitate the communication of private information in a secure manner in order to support the execution of transactions in a wireless environment.

### SUMMARY

Embodiments of the present invention relate to methods and systems for conducting transactions with wireless communications devices using a secure interactive service. Pursuant to certain embodiments of the invention, methods and systems are provided for conducting secure transactions between a wireless communications device and a virtual call center that receives private information using a secure interactive service.

In accordance with one embodiment, a method for conducting a secure transaction is provided. The method comprises receiving, at a virtual call center, an electronic message including a key text phrase, the electronic message being sent from a wireless communications device of a consumer and addressed to an automated service identifier. The method further comprises determining, at the virtual call center, transaction information based on at least one of the key text phrase, the automated service identifier, or an identifier of the wireless communications device. The transaction information may include at least an identity of a merchant. The method further comprises providing to the wireless communications device a secure interactive service to receive at least private information. In addition, the method comprises receiving, at the virtual call center, at least the private information through the secure interactive service, and completing the secure transaction by providing at least the transaction information and private information to the merchant.

In accordance with another embodiment, a method for conducting a secure transaction is provided. The method comprises providing an electronic message including a key text phrase to a virtual call center. The electronic message may be sent from a wireless communications device of a consumer and addressed to an automated service identifier. The virtual call center may determine transaction information based on at least one of the key text phrase, the automated service identifier, or an identifier of the wireless communications device. In addition, the method comprises receiving, at the wireless communications device, a secure interactive service for providing at least private information, and providing at least the private information to the virtual call center through the secure interactive service, whereby the virtual call center completes the secure transaction by providing at least the transaction information and private information to a merchant.

In accordance with another embodiment, a system for conducting a secure transaction is provided. The system comprises means for receiving, at a virtual call center, an electronic message including a key text phrase. The electronic message is sent from a wireless communications device of a consumer and addressed to an automated service identifier. The system further comprises means for determining, at the virtual call center, transaction information based on at least one of the key text phrase, the automated service identifier, or an identifier of the wireless communications device. The transaction information includes at least an identity of a merchant. The system further comprises means for providing to the wireless communications device a secure interactive service to receive at least private information. The system further comprises means for receiving, at the virtual call center, at least the private information through the secure interactive service and means for completing the secure transaction by providing at least the transaction information and the private information to the merchant.

In accordance with another embodiment, a computer-readable storage medium having instructions for executing a method for conducting a secure transaction is provided. The method comprises providing an electronic message including a key text phrase to a virtual call center, the electronic message being sent from a wireless communications device of a consumer and addressed to an automated service identifier. The virtual call center determines transaction information based on at least one of the key text phrase, the automated service identifier, or an identifier of the wireless communications device. The transaction information includes at least an identity of a merchant. The method further comprises receiving, at the wireless communications device, a secure interactive service for providing at least private information and providing at least the private information through the secure interactive service to the virtual call center. Thereafter, the virtual call center completes the secure transaction by providing at least the transaction information and the private information to the merchant.

Consistent with an aspect of the invention, providing the secure interactive service comprises directing a browser of the wireless communications device to a secure web site through which the consumer can provide at least the private information.

Consistent with an aspect of the invention, providing the secure interactive service comprises initiating an interactive voice response call to the wireless communications device through which the consumer can provide at least the private information.

Consistent with an aspect of the invention, providing the secure interactive service comprises a live representative contacting the wireless communication device to whom the consumer can provide at least the private information.

Consistent with an aspect of the invention, the electronic message is at least one of a Simple Message Service (SMS) message, an electronic mail (email) message, a Multimedia Messaging Service (MMS) message, an instant messaging (IM), or a chat message.

Consistent with an aspect of the invention, the automated service identifier is at least one of a short code number, a common short code (CSC) number, a telephone number, an email address, an SMS address, or an MMS address.

Consistent with an aspect of the invention, the transaction information comprises at least one of merchant information, consumer information, or product information. The merchant information may include at least one of the identity of the merchant, a merchant address, a merchant email address, or a merchant telephone number. The consumer information may include at least one of an identity of the consumer, a consumer address, a consumer email address, or a consumer telephone number. The product information may include at least one of a good or service, a quantity, a price, or options.

Consistent with an aspect of the invention, the private information includes at least payment information. The payment information may include at least one of an identity of a payer, a credit card number, a bank routing number, an account number, or a billing address.

It is to be understood that both the foregoing general description and the following detailed description are exemplary and explanatory only, and are not restrictive of the scope of the invention, described and as claimed. Furthermore, features and variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this specification, illustrate various embodiments of the invention and together with the detailed description, serve to explain the principles of the invention.

FIG. 1 illustrates an exemplary environment for conducting a secure transaction with a wireless communications device, consistent with an embodiment of the invention.

FIG. 2 is a flow chart of an exemplary method for conducting a secure transaction, consistent with an embodiment of the invention.

FIG. 3 illustrates an exemplary system for implementing a virtual call center, consistent with an embodiment of the invention.

FIG. 4 illustrates an exemplary computing platform, consistent with an embodiment of the invention.

### DETAILED DESCRIPTION

Reference will now be made in detail to the present invention, examples of which are illustrated in the accompanying drawings. Wherever possible, the same reference numbers will be used throughout the drawings to refer to the same or like parts.

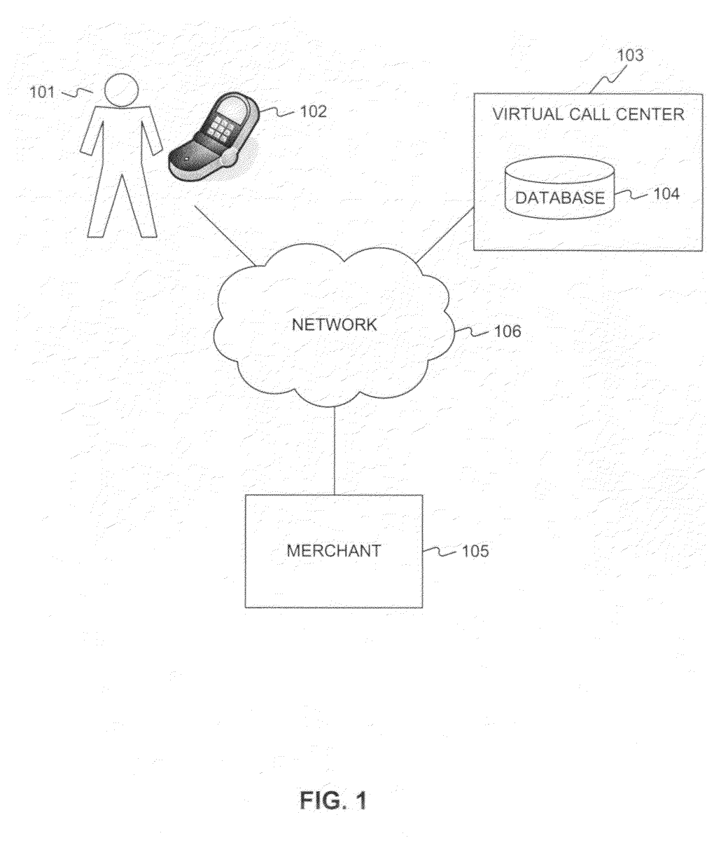

FIG. 1 illustrates an exemplary environment for conducting a secure transaction with a wireless communications device, consistent with an embodiment of the invention. The exemplary environment of FIG. 1 includes a consumer 101 with a wireless communications device 102. Wireless communications device 102 may be a cellular telephone or any device capable of sending an electronic message wirelessly, such as a PDA or a laptop. Consistent with an embodiment, consumer 101 may conduct a transaction (e.g., an order for a good or service) by sending an electronic message using wireless communications device 102. The electronic message may be communicated through a network 106 to a virtual call center (VCC) 103. Network 106 may comprise, for example, the Internet, a cellular network such as the Global System for Mobile (GSM) network, a telephone network, a local area network (LAN), a wide area network (WAN), or an SMS network, or any combination thereof. Upon receipt of the electronic message, virtual call center 103 may determine transaction information based on a database 104. Virtual call center 103 may then provide a secure interactive service to wireless communications device 102, such that consumer 101 can provide, for example, payment information and/or other private information to virtual call center 103 securely. Virtual call center 103 may then complete the transaction by sending at least the transaction information and the payment information to a merchant 105 identified based on database 104. Although one consumer, one virtual call center, and one merchant are shown in FIG. 1, any number of consumers, virtual call centers, and merchants may be provided.

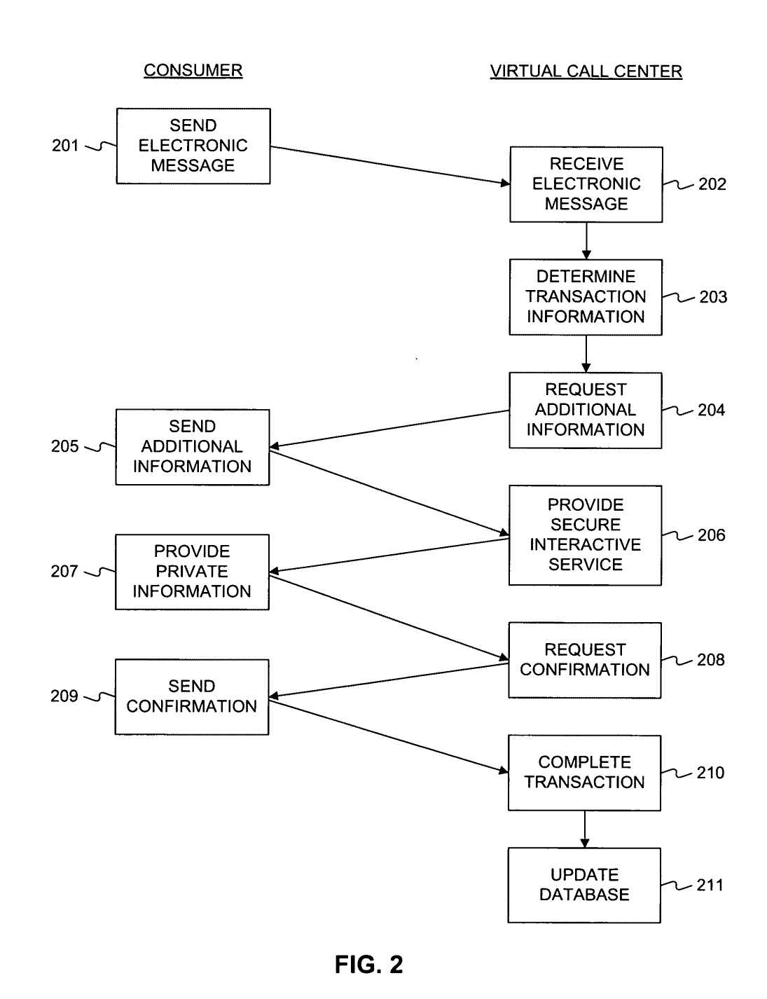

Exemplary methods consistent with embodiments of the invention will now be explained in greater detail in reference to FIG. 2. FIG. 2 is a flow chart of an exemplary method for conducting a secure transaction. In this drawing, the steps shown on the left side of FIG. 2 are performed by a consumer (such as consumer 101) and the steps on the right side of FIG. 2 are performed by a virtual call center (such as virtual call center 103).

Referring to FIG. 2, in step 201, consumer 101 sends an electronic message using wireless communications device 102. The electronic message may be sent by consumer 101 to perform a transaction, such as placing an order for a good or service. The electronic message may comprise, for example, an SMS message, an electronic mail (email) message, a Multimedia Messaging Service (MMS) message, an instant messaging (IM), or a chat message.

The electronic message from consumer 101 may include a key text phrase. The key text phrase may relate to the transaction and indicate, for example, a good or service desired by consumer 101, a quantity of the desired product, merchant 105 offering the good or service, or any combination thereof. In one embodiment, the key text phrase may be any combination of alphanumeric characters. The key text phrase may be one word or may be multiple words, and may include numbers, special characters, or symbols.

The electronic message from consumer 101 may be addressed using an automated service identifier. In one embodiment, the automated service identifier may relate to a merchant 105, who offers products or services. In one alternative embodiment, several merchants may share one automated service identifier. In yet another embodiment, the automated service identifier may cause the electronic message to be sent to virtual call center 103 that handles transactions for merchant 105 and/or other more merchants (not shown). The automated service identifier may comprise, for example, a short code number, a common short code (CSC) number, a telephone number, a facsimile (fax) number, an email address, an SMS address, and an MMS address.

Consistent with embodiments of the invention, consumer 101 may obtain the key text phrase and/or the automated service identifier through an advertisement on television, or information provided in a magazine, a newspaper, or via the Internet. The key text phrase and/or the automated service identifier may also be communicated to consumer 101 by other consumers or through word-of-mouth.

For purposes of illustration, assume that merchant 105 is a taco vendor. Merchant 105 may advertise on television, instructing viewers to send an SMS message of “5 grande” to a CSC number “82267” to order five large tacos from the taco vendor. A CSC number may spell out a word or phrase using associated numbers on an alphanumeric telephone keypad. In this example, “82267” spells out “TACOS” on an alphanumeric telephone keypad. Through such an advertisement, a consumer 101 may correlate the combination of “5 grande” and “82267” with an order for five large tacos from the particular taco vendor.

Referring again to FIG. 2, in step 202, virtual call center 103 receives the electronic message from consumer 101. As noted above, the electronic message may be addressed using an automated service identifier. With the automated service identifier, the electronic message is sent via a network 106 to virtual call center 103. In one embodiment, virtual call center 103 may receive and process orders for transactions initiated by consumer 101 and/or other consumers (not shown). Virtual call center 103 may forward information concerning an order to merchant 105 and/or other merchants to complete each transaction.

The type of network 106 and components of network 106 involved in the communication of electronic messages may depend on the form of the electronic message and automated service identifier. For example, if consumer 101 sends an email to an email address, the email may be routed through the Internet and/or various routers before reaching an email server. As another example, if consumer 101 sends an SMS message to a CSC number, the SMS message may be routed through the GSM network and through an SMS gateway.

Consistent with one embodiment, the automated service identifier may be assigned to virtual call center 103. For example, an SMS message containing a key text phrase may be sent to a CSC number leased by virtual call center 103. As another example, an email containing a key text phrase may be sent to an email address of virtual call center 103.

Consistent with another embodiment, consumer 101 may send an electronic message to an automated service identifier of merchant 105, in which case the electronic message would be routed or forwarded to virtual call center 103. For example, merchant 105 who leases a CSC number may update a CSC aggregator such that the CSC aggregator will route the electronic message sent to the CSC number leased by merchant 105 to virtual call center 103. As another example, merchant 105 may configure its email server such that an email containing a key text phrase sent to an email address of merchant 105 is forwarded to virtual call center 103.

Referring again to FIG. 2, in step 203, virtual call center 103 determines transaction information based on the electronic message, the automated service identifier, and/or an identifier (ID) of wireless communications device 102. The ID of wireless communications device 102 may include, for example, a telephone number, an SMS address, an email address, an Internet Protocol (IP) address, and/or a Media Access Control (MAC) address.

Transaction information may include merchant information, consumer information, and/or product information. Merchant information may include, for example, an identity of merchant 105, a postal address, an email address, a telephone number, and a fax number. Consumer information may include, for example, an identity of consumer 101, a postal address, an email address, a telephone number, and/or a fax number. Product information may include, for example, identity of a good or service, a quantity, a price, and option(s) related to the good or service, such as color, size, etc.

As shown in FIG. 1, virtual call center 103 may have a database 104 storing various associations, which are used to determine transaction information. For example, database 104 may store associations between merchants and automated service identifiers. Virtual call center 103 may determine which merchant consumer 101 wishes to purchase from by referencing database 104 using the automated service identifier.

As another example, database 104 may store associations between products and key text phrases, such that virtual call center 103 can determine which product consumer 101 wishes to purchase by referencing database 104 using the key text phrase.

As another example, database 104 may store associations between identities of consumers and IDs of wireless communications devices, such that virtual call center 103 can determine the identity of consumer 101 by referencing database 104 using the ID of wireless communications device 102. In one embodiment, virtual call center 103 may store in database 104 information of pre-registered consumers or customers who have previously ordered from virtual call center 103. For example, a pre-registered customer may have an association between the ID of his wireless communications device and shipping and/or billing information.

The above-referenced examples of associations in database 104 are merely exemplary. In database 104, any combination of information can be associated with any combination of information. The associations stored in database 104 determine what transaction information can be determined by virtual call center 103. For example, if a particular combination of key text phrase and automated service identifier are associated with a particular merchant, then only the merchant can be determined based on the key text phrase and the automated service identifier. However, if a particular automated service identifier is associated with a combination of a particular merchant, product, quantity, and price, then the merchant, the desired product, the desired quantity, and the price can all be determined based on just the automated service identifier.

In one embodiment, virtual call center 103 may request shipping and/or billing information from the carrier of wireless communications device 102. Or, in another embodiment, virtual call center 103 may verify shipping and/or billing information obtained from the carrier of wireless communications device 102 with that obtained from consumer 101. A carrier may be a telephone company that provides telecommunications services such as telephony and data communications. A carrier may be an organization that operates a wireless network for mobile phones.

Consistent with one embodiment, in step 204 of FIG. 2, virtual call center 103 may request additional information from consumer 101. For example, if virtual call center 103 can determine the identity of merchant 105 and the product based on the key text phrase and the automated service identifier in the electronic message, virtual call center 103 may request other information such as the quantity of products desired by the consumer. Virtual call center 103 may also need to know and request the shipping address, etc.

In one embodiment, the request for additional information may include options related to the transaction. For example, virtual call center 103 may present consumer 101 with options for available shipping methods and a selection of colors of the product.

In another embodiment, the request for additional information may include a request for a confirmation or verification of information for the order from consumer 101. The confirmation request may contain the transaction information that was determined by virtual call center 103 and, if applicable, additional information provided by consumer 101.

In one embodiment, virtual call center 103 may request additional information from consumer 101 using the same method of communication used by consumer 101 to send the electronic message. For example, if consumer 101 placed an order by sending an SMS message using wireless communications device 102, virtual call center 103 may request additional information by sending another SMS message to wireless communications device 102 of consumer 101. Or, if consumer 101 placed an order by sending an email, virtual call center 103 may request additional information by sending another email (e.g., replying to the original email) to wireless communications device 102 of consumer 101.

Alternatively, virtual call center 103 may use a different method of communication to request additional information than the method used by consumer 101 to place the order.

In step 205 in FIG. 2, consumer 101 may respond to the request for additional information from virtual call center 103 (if applicable). The response may include another electronic message that includes the requested information.

Referring again to FIG. 2, in step 206, virtual call center 103 may initiate or provide a secure interactive service for wireless communications device 102. Consistent with embodiments of the present invention, the secure interactive service may include a secure web site or an Interactive Voice Response (IVR), or any other means of securely providing information including communicating with a live representative. In step 207, consumer 101 may provide private information through the secure interactive service.

The type of secure interactive service initiated or provided by virtual call center 103 may be predetermined, may be selected by consumer 101, or may be dependent upon factors such as the capability of wireless communications device 102 or preference of merchant 105 or consumer 101.

Private information may include any information that consumer 101 (and/or merchant 105) wishes to keep confidential and transmit securely. In one embodiment, private information may include, for example, payment information. Payment information may include, for example, an identity of a payer, a credit card number, a bank routing number, an account number, a billing address, an email address, a telephone number, and a fax number.

In one embodiment, virtual call center 103 may direct a browser on wireless communications device 102 to a secure web site through which consumer 101 may provide private information securely. The secure web site may employ various security features including encryption and authentication. For this purpose, conventional security technology may be employed, such as secure sockets layer (SSL) and digital certificates. The secure web site may be hosted by virtual call center 103, merchant 105, and/or a third party. For example, virtual call center 103 may send a wireless application protocol (WAP) push including an address or universal resource locator (URL) of the secure web site to wireless communications device 102. Wireless communications device 102 receiving the WAP push may then start a browser and open the secure web page. The user may enter the private information on the secure web page. The private information may then be received by virtual call center 103. For example, the secure web page may be a WAP page capable of being browsed by a WAP browser on a WAP-enabled wireless communications device. In one embodiment, the secure web page may contain fillable forms in which consumer 101 may enter various data including private information.

In another embodiment, virtual call center 103 may initiate an IVR call to wireless communications device 102 of consumer 101. Consumer 101 may then accept the IVR call and provide private information to virtual call center 103 through IVR techniques. For example, the IVR call may include menus of automated voice message prompts requesting consumer 101 to enter, for example, a credit card number using a telephone keypad or to speak the credit card number, which the IVR system can understand through a speech recognition (speech-to-text) system. By way of example, virtual call center 103 may make an IVR call to wireless communications device 102 in response to an SMS message of “5 grande” sent to “82267,” and the IVR may prompt: “You wish to order 5 large tacos. If this is correct, press 1. If this is incorrect, press 2.” If wireless communications device 102 responds with the touchtone for 1 or consumer 101 speaks the word “one” into wireless communications device 102, then the IVR system may continue the process by requesting information through further automated voice message prompts.

In another embodiment, a live representative may contact consumer 101 through wireless communications device 102. The live representative may be employed by virtual call center 103, merchant 105, or a third party contractor. The live representative may contact consumer 101 via any means including, for example, calling wireless communications device 102 or initiating a chat session with wireless communications device 102. Consumer 101 may then provide private information to the live representative.

Consistent with one embodiment, the electronic message, additional information, a confirmation, and/or private information may be sent from wireless communications device 102 using java technology encryption such that the encrypted data can be submitted over SMS.

Referring again to FIG. 2, in step 208, virtual call center 103 may send a confirmation request to consumer 101 (perhaps for the second, third, or subsequent time). The confirmation request may contain all or some of the information relevant to the transaction. The confirmation request may give consumer 101 an opportunity to review the order and verify the information before approving the transaction in step 209.

In step 210, virtual call center 103 may complete the transaction by providing at least the transaction information and the private information to merchant 105. The transaction information and the private information may be provided to merchant 105 through any form of communication. For example, virtual call center 103 may compose an email containing the transaction information and the payment information to merchant 105. As another example, virtual call center 103 may prepare an order form containing the transaction information and the private information and mail or fax the order form to merchant 105. The communication between virtual call center 103 and merchant 105 may be conducted through the same network 106 used by consumer 101 or may be conducted through a different network.

In step 211, virtual call center 103 may update database 104 to, for example, update existing associations in database 104 or add new associations to database 104. These updates may be based on the information obtained during the above-described processes. For example, if consumer 101 who placed an order is not in database 104, virtual call center 103 may create a new association between consumer 101 and the ID of wireless communications device 102 in database 104, such that the next time consumer 101 places an order with virtual call center 103 using the same wireless communications device 102, virtual call center 103 may determine the identity of consumer 101 based on the ID of wireless communications device 102 by referencing database 104.

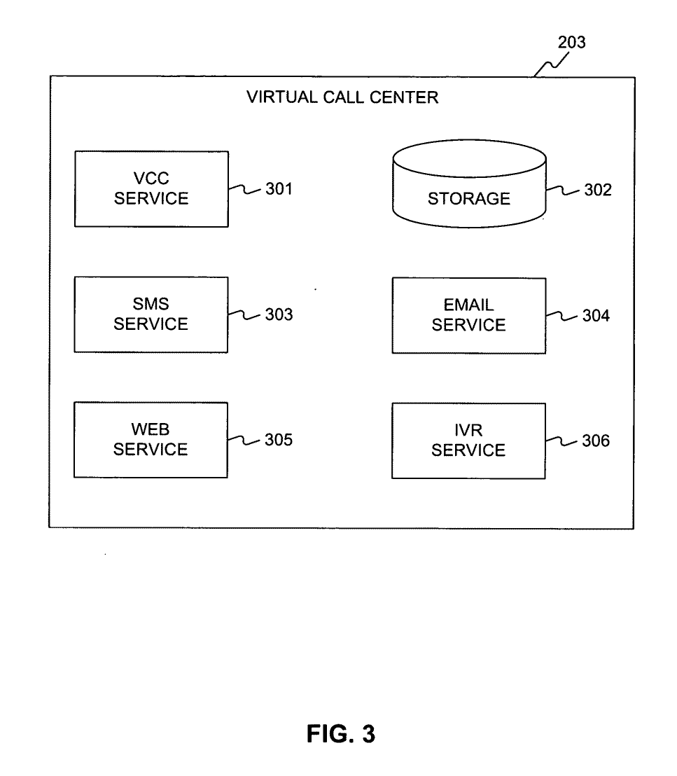

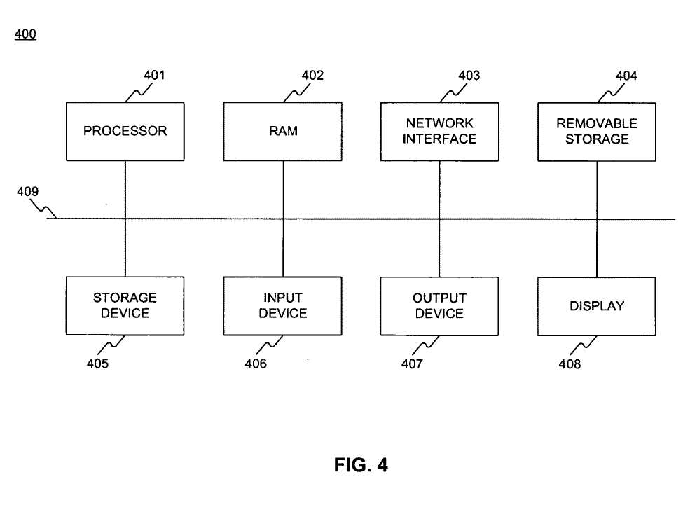

FIG. 3 illustrates an exemplary system for implementing virtual call center 103, consistent with an embodiment of the invention. The exemplary system of FIG. 3 may be implemented through any suitable combination of hardware, software, and/or firmware. In one embodiment, the components shown in FIG. 3 (with the exception of storage 302) are implemented with software running on a server, processor, or computing platform (see FIG. 4). Furthermore, any of the components of virtual call center 103 may be implemented by one application, or may be distributed among several applications.

As shown in FIG. 3, virtual call center 103 may comprise a virtual call center (VCC) service 301. VCC service 301 may perform any or all of the above-described processes of virtual call center 103. Virtual call center 103 may further comprise a storage 302. Storage 302 may store, among other things, all of the above-described information contained in database 104, including associations. Virtual call center 103 may further comprise an SMS service 303, acting as an SMS gateway, for sending and receiving SMS messages from cellular and SMS networks. Virtual call center 103 may further comprise an email service 304 for sending and receiving email messages.

Additionally, as shown in FIG. 3, virtual call center 103 may comprise a web service 305. Web service 305 may host a secure web site employing various security features. In one embodiment, web service 305 hosts a WAP site, which supports WAP browsers and other browsers on wireless communications devices. Web service 305 may host and publish ASP.NET based web applications.

Virtual call center 103 may further comprise an IVR service 306. IVR service 306 may be capable of calling and receiving calls. IVR service 306 may includes automated voice message prompts, a touchtone recognition system, and a speech recognition system.

FIG. 4 illustrates an exemplary computing platform 400, consistent with an embodiment of the invention. Computing platform 400 may be utilized for implementing virtual call center 103.

In the example of FIG. 4, computing platform 400 includes a processor 401 for executing instructions to perform processes related to providing a secure transaction, consistent with the present invention. Processor 401 may be connected to a data bus 409, which connects various components of computing platform 400. Computing platform 400 may include a storage device 405 for storing data related to the secure transaction, such as database 104. RAM 402 memory may be used by processor 401 as a placeholder for active data during the execution of instructions. Computing platform 400 may also comprise one or more input devices 406, for example, a keyboard and a mouse. A network interface 403 may allow computing platform 400 to be connected to network 106. Computing platform 400 may comprise a removable storage 404 such as a floppy drive, CDROM, DVD-ROM, and USB flash drive. Computing platform 400 may also comprise a display 408, such as a monitor, and an output device 407, such as a printer or a fax machine.

The present techniques and embodiments described herein, including the exemplary systems and methods presented above, can be implemented in digital electronic circuitry, or in computer hardware, firmware, software, or in any suitable combinations thereof. In addition, apparatus consistent with the present invention can be implemented in a computer program product tangibly embodied in a machine-readable storage device for execution by a programmable processor.

Method steps according to embodiments of the invention can be performed by a programmable processor executing a program of instructions to perform functions or steps of the methods by operating based on input data, and by generating output data. Embodiments of the invention may also be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, or in assembly or machine code. The language or code can be a compiled or interpreted language or code. Processors may include general and special purpose microprocessors. A processor receives instructions and data from memories, in particular from read-only memories or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in application-specific integrated circuits (ASICs).

To provide for interaction with a user, aspects of the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g., an RF communication link). A display is coupled to an interface, which is coupled to an I/O bus. A keyboard and pointing device are also coupled to the I/O bus. Alternatively, separate buses may be used for the keyboard pointing device and I/O interface.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for conducting a secure transaction, comprising:
receiving, at a virtual call center, an electronic message including a key text phrase, the electronic message being sent from a wireless communications device of a consumer and being addressed to an automated service identifier;
determining, at the virtual call center, transaction information based on at least one of the key text phrase, the automated service identifier, or an identifier of the wireless communications device, the transaction information including at least an identity of a merchant;
providing to the wireless communications device a secure interactive service to receive at least private information;
receiving, at the virtual call center, at least the private information through the secure interactive service; and
completing the secure transaction by providing at least the transaction information and the private information to the merchant.

2. The method of claim 1, wherein providing the secure interactive service comprises directing a browser of the wireless communications device to a secure web site through which the consumer can provide at least the private information.

3. The method of claim 1, wherein providing the secure interactive service comprises providing an interactive voice response call to the wireless communications device through which the consumer can provide at least the private information.

4. The method of claim 1, wherein providing the secure interactive service comprises a live representative contacting the wireless communications device to whom the consumer can provide at least the private information.

5. The method of claim 1, wherein the electronic message is at least one of a Simple Message Service (SMS) message, an electronic mail (email) message, a Multimedia Messaging Service (MMS) message, an instant messaging (IM), or a chat message.

6. The method of claim 1, wherein the automated service identifier is at least one of a short code number, a common short code (CSC) number, a telephone number, an email address, an SMS address, or an MMS address.

7. The method of claim 1, wherein the transaction information comprises at least one of merchant information, consumer information, or product information, the merchant information including at least one of the identity of the merchant, a merchant address, a merchant email address, or a merchant telephone number, the consumer information including at least one of an identity of the consumer, a consumer address, a consumer email address, or a consumer telephone number, and the product information including at least one of a good or service, a quantity, a price, and options.

8. The method of claim 1, wherein the private information includes at least payment information, the payment information including at least one of an identity of a payer, a credit card number, a bank routing number, an account number, or a billing address.

9. A method of conducting a secure transaction, comprising:
providing, to a virtual call center, an electronic message including a key text phrase, the electronic message being sent from a wireless communications device of a consumer and being addressed to an automated service identifier;
receiving, at the wireless communications device, a secure interactive service for providing at least private information; and
providing, to the virtual call center, at least the private information through the secure interactive service so that the virtual call center can complete the secure transaction by providing at least the private information and transaction information to a merchant, wherein the virtual call center determines the transaction information based on at least one of the key text phrase, the automated service identifier, and an identifier of the wireless communications device.

10. The method of claim 9, wherein receiving the secure interactive service comprises a browser of the wireless communications device being directed to a secure web site through which the consumer can provide at least the private information.

11. The method of claim 9, wherein receiving the secure interactive service comprises receiving, at the wireless communications device, an interactive voice response call through which the consumer can provide at least the private information.

12. The method of claim 9, wherein receiving the secure interactive service comprises being contacted, on the wireless communications device, by a live representative to whom the consumer can provide at least the private information.

13. The method of claim 9, wherein the electronic message is at least one of a Simple Message Service (SMS) message, an electronic mail (email) message, a Multimedia Messaging Service (MMS) message, an instant messaging (IM), or a chat message.

14. The method of claim 9, wherein the automated service identifier is at least one of a short code number, a common short code (CSC) number, a telephone number, an email address, an SMS address, or an MMS address.

15. The method of claim 9, wherein the transaction information comprises at least one of merchant information, consumer information, or product information, the merchant information including at least one of the identity of the merchant, a merchant address, a merchant email address, or a merchant telephone number, the consumer information including at least one of an identity of the consumer, a consumer address, a consumer email address, or a consumer telephone number, and the product information including at least one of a good or service, a quantity, a price, and options.

16. The method of claim 9, wherein the private information includes at least payment information, the payment information including at least one of an identity of a payer, a credit card number, a bank routing number, an account number, or a billing address.

17. A system for conducting a secure transaction, comprising:
means for receiving, at a virtual call center, an electronic message including a key text phrase, the electronic message being sent from a wireless communications device of a consumer and being addressed to an automated service identifier;
means for determining, at the virtual call center, transaction information based on at least one of the key text phrase, the automated service identifier, or an identifier of the wireless communications device, the transaction information including at least an identity of a merchant;
means for providing to the wireless communications device a secure interactive service to receive at least private information; and
means for receiving, at the virtual call center, at least the private information through the secure interactive service, so that the virtual call center can complete the secure transaction by providing at least the transaction information and the private information to the merchant.

18. The system of claim 17, wherein the means for providing the secure interactive service comprises means for directing a browser of the wireless communications device to a secure web site through which the consumer can provide at least the private information.

19. The system of claim 17, wherein the means for providing the secure interactive service comprises means for providing an interactive voice response call to the wireless communications device through which the consumer can provide at least the private information.

20. The system of claim 17, wherein the means for providing the secure interactive service comprises means for a live representative to contact the wireless communications device to whom the consumer can provide at least the private information.

21. The system of claim 17, wherein the electronic message is at least one of a Simple Message Service (SMS) message, an electronic mail (email) message, a Multimedia Messaging Service (MMS) message, an instant messaging (IM), or a chat message.

22. The system of claim 17, wherein the automated service identifier is at least one of a short code number, a common short code (CSC) number, a telephone number, an email address, an SMS address, or an MMS address.

23. The system of claim 17, wherein the transaction information comprises at least one of merchant information, consumer information, or product information, the merchant information including at least one of the identity of the merchant, a merchant address, a merchant email address, or a merchant telephone number, the consumer information including at least one of an identity of the consumer, a consumer address, a consumer email address, or a consumer telephone number, the product information including at least one of a good or service, a quantity, a price, or options.

24. The system of claim 17, wherein the private information includes at least payment information, the payment information including at least one of an identity of a payer, a credit card number, a bank routing number, an account number, or a billing address.

25. A computer-readable storage medium having instructions for executing a method for conducting a secure transaction, the method comprising:
receiving, at a virtual call center, an electronic message including a key text phrase, the electronic message being sent from a wireless communications device of a consumer and being addressed to an automated service identifier;
determining, at the virtual call center, transaction information based on at least one of the key text phrase, the automated service identifier, or an identifier of the wireless communications device, the transaction information including at least an identity of a merchant;
providing to the wireless communications device a secure interactive service to receive at least private information;
receiving, at the virtual call center, at least the private information through the secure interactive service; and
completing the secure transaction by providing at least the transaction information and the private information to the merchant.

26. The computer-readable storage medium of claim 25, wherein providing the secure interactive service comprises directing a browser of the wireless communications device to a secure web site through which the consumer can provide at least the private information.

27. The computer-readable storage medium of claim 25, wherein providing the secure interactive service comprises providing an interactive voice response call to the wireless communications device through which the consumer can provide at least the private information.

28. The computer-readable storage medium of claim 25, wherein providing the secure interactive service comprises a live representative contacting the wireless communications device to whom the consumer can provide at least the private information.

29. The computer-readable storage medium of claim 25, wherein the electronic message is at least one of a Simple Message Service (SMS) message, an electronic mail (email) message, a Multimedia Messaging Service (MMS) message, an instant messaging (IM), or a chat message.

30. The computer-readable storage medium of claim 25, wherein the automated service identifier is at least one of a short code number, a common short code (CSC) number, a telephone number, an email address, an SMS address, or an MMS address.

31. The computer-readable storage medium of claim 25, wherein the transaction information comprises at least one of merchant information, consumer information, or product information, the merchant information including at least one of the identity of the merchant, a merchant address, a merchant email address, or a merchant telephone number, the consumer information including at least one of an identity of the consumer, a consumer address, a consumer email address, or a consumer telephone number, the product information including at least one of a good or service, a quantity, a price, or options.

32. The computer-readable storage medium of claim 25, wherein the private information includes at least payment information, the payment information including at least one of an identity of a payer, a credit card number, a bank routing number, an account number, or a billing address.
